(19) United States
(12) Patent Application Publication
(10) Pub. No.: US 2012/0057469 A1
(43) Pub. Date: Mar. 8, 2012

(54) Data transfer in large network in efficient manner.

(76) Inventor: Praveen Kumar, Bangalore (IN)

(21) Appl. No.: 13/319,126

(22) PCT Filed: Feb. 11, 2010
(86) PCT No.: PCT/IN2010/000080

§ 371 Date: Nov. 7, 2011

(30) Foreign Application Priority Data
May 22, 2009 (IN) 1171/CHE/2009

(51) Int. Cl. H04L 12/26; H04J 3/06

(52) U.S. Cl. 370/238; 370/350

(57) ABSTRACT

The embodiments herein generally relate to distributed systems and more particularly, to data propagation in a large network. This invention enables the network to support data propagation in plurality of directions based on configuration. Using this method data propagation is equally fast and deterministic in all the configured directions. Here, superframe duration is divided into plurality of data cycle period, which is further divided into plurality of time zones each dedicated to support a specific directional data flow. This method improves the power efficiency of data propagation, enables user to configure any directional data propagation and reduces the delay.

### FIELD OF THE INVENTION

The embodiments herein generally relate to large network formation and its working, more particularly, the data propagation in efficient manner in all configurable directions with minimum delay in large distributed systems.

### CROSS REFERENCE TO RELATED APPLICATIONS

This specification is the complete specification of the provisional application No. 1171/CHE/2009 filed on 22^{nd} May, 2009 which it claims to be its priority date.

### BACKGROUND TO THE INVENTION

Maintaining large networks is a challenging issue; activities such as synchronization, data transfer between the nodes, failure detection and recovery with minimum delay are challenging tasks. In large networks data has to travel through plurality of hops. At each hop delay will be added, since we know that the data can be transmitted only in active period, which comes periodically in every superframe for a small period of time compared to superframe duration. The types of applications the low rate wireless personal area network (LR-WPAN) supports and for the network durability, it is observed that typically the active period shall be in the range of less than 1%. As per existing standards, the network time domain (superframe) is designed in such a way that data propagation is normally faster in one direction. Data propagation in reverse direction takes plurality of times longer period than in the direction data propagation is supported. Existing design support single hop data transfer in every superframe duration in reverse direction. Definitely this is a big limitation of existing design. Scenarios such as border area surveillance, where the intruder detection event happens occasionally but whenever happen, it shall be notified to the control room with minimum delay. In such scenario, if the system will be configured with high beacon periodicity i.e. small superframe duration, so that the data gets transferred with minimum delay, then lots of energy will be wasted in synchronization process, and if the beacon periodicity is reduced then data transfer will take very long time which may not be acceptable. In this invention we have developed an algorithm which allows the network elements to transfer the data between the layers in any direction, with minimum and deterministic delay and in power efficient manner. As part of this invention the algorithm has been also extended to design event based network system.

### BRIEF DESCRIPTION OF THE DRAWINGS

The present invention is illustrated by way of example, and not by way of limitation. In the figures of the accompanying drawings and in which like reference numerals refer to similar elements and in which:

FIG. 1 illustrates an exemplary wireless sensor network (WSN).

FIG. 2 illustrates an exemplary single receive attempt scenario.

FIG. 3 illustrates an exemplary plurality of reception attempt scenario.

FIG. 4 illustrates an exemplary message indication sequence format.

FIG. 5 illustrates an exemplary time domain of transmitting and receiving nodes in different scenarios with respect to absolute time.

FIG. 6 illustrates exemplary data propagation time domain of a network having even number of layers, in forward and reverse directions, where network is divided into two clusters and has an interface layer.

FIG. 7 illustrates exemplary data propagation time domain of a network having odd number of layers, in forward and reverse directions, where network is divided into two clusters and has an interface layer.

FIG. 8 illustrates exemplary data propagation in forward and reverse directions and also illustrates configurable parameters.

FIG. 9 illustrates exemplary synchronization information propagation time domain.

FIG. 10 illustrates exemplary time domain at PC in case forward direction data flow, highlighting the scenario that PC doesn't have previous layer to listen.

### DESCRIPTION OF THE EMBODIMENTS

Various embodiments of the present invention provide a method for the devices to propagate data between any nodes in the fastest and efficient way. As an example the present invention has been illustrated in the context of a wireless sensor network (WSN). However, it will be apparent to those ordinarily skilled in the art the applicability of the invention to many other distributed systems.

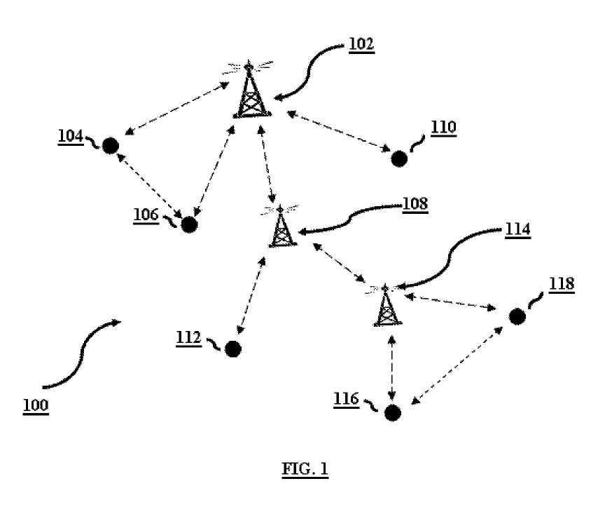

FIG. 1 illustrates exemplary wireless ad-hoc communication network (WCN) architecture 100, in accordance with various embodiments of the present invention. The WCN 100 includes a full function device personal area network controller (PC) 102, plurality of full function device network coordinators (NC) 108, 114 at different depth from the PC and plurality of reduced function device leaf nodes (LNs) 104, 106, 110, 112, 116 and 118 at different depth from the PC. For embodiments herein, the PC 102 exchanges data with the NC 108 and LNs 104, 106 and 110 within its radio sphere of influence. The nodes directly associated with the PC are termed as 1^{st} level nodes or 1^{st} hop nodes. For the higher level of association, full function device NCs allow the nodes to associate with it. As illustrated in FIG. 1, NC 108 has allowed LN 112 and NC 114 to get associated with it. In this manner the network formation happens. Further, the PC, NCs and LNs may be equipped with transducers, sensors and transceivers for obtaining data from a source and exchanging data with other LNs, NC and PC in the network. On obtaining the data, the corresponding node can transmit the necessary data to other LN, NC or PC. The PC, NC and LN also include a power source for driving the various electronic circuitries used in it. The power source can be main power or a battery, normally in remote area installation the power source is battery.

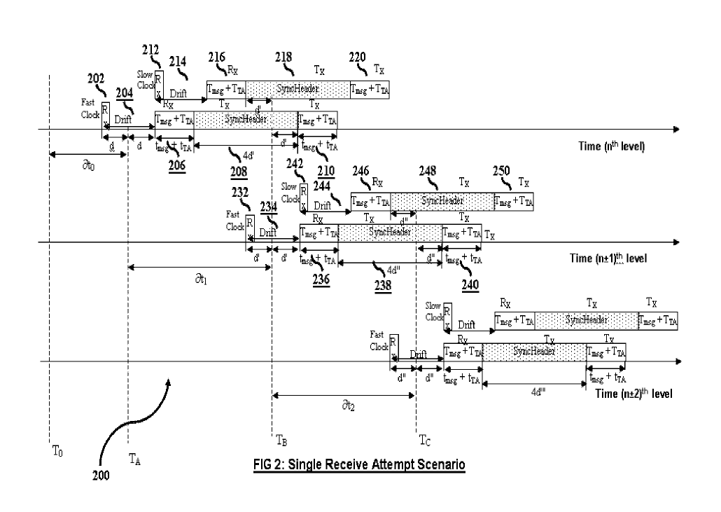

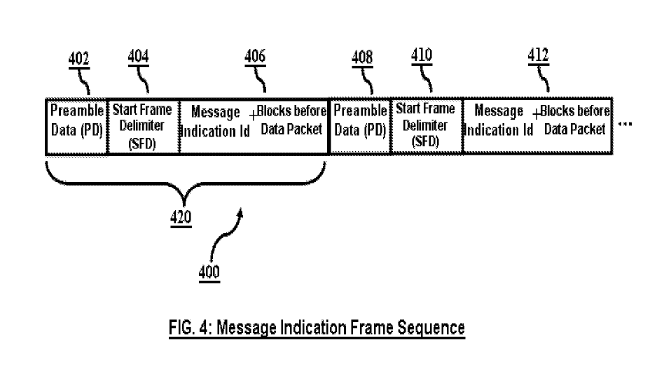

FIG. 2 illustrates the time domain of contiguous layers of NCs, when the NCs are configured to attempt to listen for any relevant data only once after every preconfigured time. 200 illustrates the n, (n+1) and (n+2)th layer node's time domain. As illustrated in FIG. 2, ∂t₀, 270, is the time after last synchronization at which the n^{th} layer node attempts to listen for any relevant information. To illustrate the extreme clock drift cases, 202 or 212 is the exemplary attempt made by nth layer node to listen to (n−1)th layer NC in the case of fast or slow clock drift respectively. 204 and 214 is the possible drift, ranging between −d to +d. Depending upon the transmitter's clock drift the NC at nth layer listens to the data at 206 or 216. The maximum possible message is configurable. 206 and 216 time period is equal to the time period of maximum possible message length, Inter frame spacing, turn-around time, data propagation delay and acknowledgement reception delay. In this document, the 206 or 216 duration is termed as T_{msg}+T_{TA} it is a configurable value, depending upon the requirement it is configured. Immediately after T_{msg}+T_{TA} duration, the node starts its transmission for the next layer. As illustrated in FIG. 2 the node first transmits the synchronization header (SyncHeader) 208 and 218, which is sequence of message indication frames (MIF) as illustrated in FIG. 4. Depending upon the clock drift of the next layer receiver node, it attempts to listen to the data at 232 or 242. As an example in the worst case where the drift is maximum possible, the node attempts to listen to the data at 232 or 242. Receiving the message indication frame (MIF) at 232 or 242, the node calculates exactly when the transmitting node will transmit its data frame i.e. 210 or 220. The receiving node switches ON its receiver exactly at that time 236 or 246 and receives the data. After receiving the data, the receiver node checks if the data has to be forwarded to next layer, in the case if the data has to be forwarded to the next layer it starts the same procedure as mentioned earlier.

The transmitter node ensures that even in worst possible case of relative drift between the transmitter node and receiver node, the receiver node listens to MIF or Synchronization Header of data frame. As mentioned earlier, the synchronization header of data frame follows MIF sequence and is consisting of 4 octets of preamble data (PD) and 1 octet of start frame delimiter (SFD) as per existing standards. To ensure that, in the case where the nodes are configured to attempt only once to check if any relevant data is getting transmitted or not, the transmitting node transmits the MIF sequence i.e. SyncHeader for 4 times the maximum possible drift at that particular instance, as shown in FIG. 2.

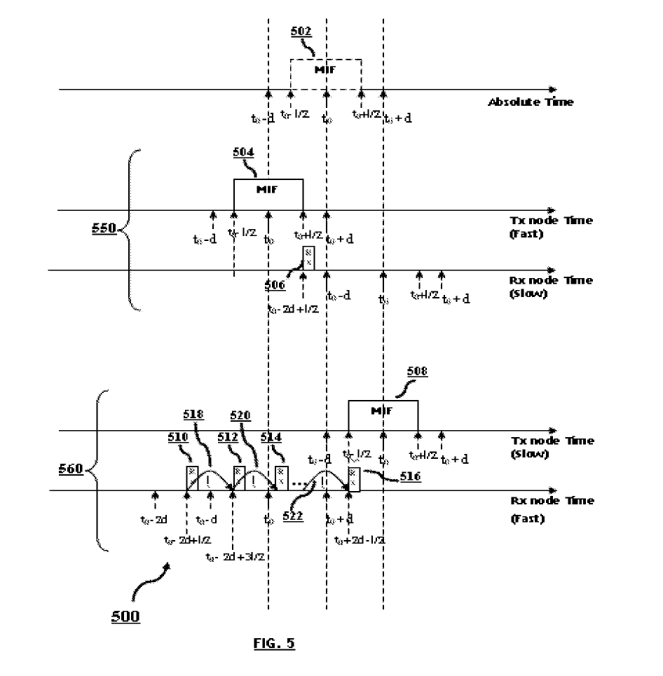

FIG. 5 illustrates the time domain of transmitting and receiving nodes in different scenarios with respect to absolute time particularly when the SyncHeader duration is less than 2 times the maximum possible drift. Scenario 550 illustrates the time domain when transmitting node is fast and receiving node is slow with respect to absolute time where as, 560 illustrates the scenario where transmitting node is slow and receiving node is fast with respect to absolute time. FIG. 5 also indicates the relationship between SyncHeader duration and number of attempts the receiving node makes to listen to data packet. As illustrated in scenario 550, the receiving node attempts to listen at 2 times the maximum possible drift minus half of SyncHeader period in advance with respect to local time i.e. t₀−(2*d−½), where t₀ is the middle of the SyncHeader period as per its local clock, d is the maximum possible drift at that particular instance, 1 is the SyncHeader period. Using this method in scenario 550, the receiving node will able to listen to synchronization header of data frame in first attempt 506, but in scenario 560 SyncHeader starts at t₀+(2*d−½) with respect to its local clock. If the receiving node attempts to listen to relevant data ‘A’ times, the node has to scan the duration from t₀−(2*d−½) to t₀+(2*d−½) in A attempts. Since the first attempt is already made at t₀−(2*d−½):

$$( {t}_{0} + ( 2 * d - l / 2 ) ) - ( {t}_{0} - ( 2 * d - l / 2 ) ) = ( A - 1 ) * l \\ ⇒ l = \frac{4 d}{A} \\ Therefore \\ {L}_{MIF} = \frac{4 * Δ * t}{A} \qquad equation 1$$

where,
d=A*t;
L_{MIF} is the duration of MIF sequence i.e. SyncHeader;
Δ is the maximum drift supported by the network;
t is the time at any particular instance; and
A is the number of attempts the receiving node makes to listen to relevant data;

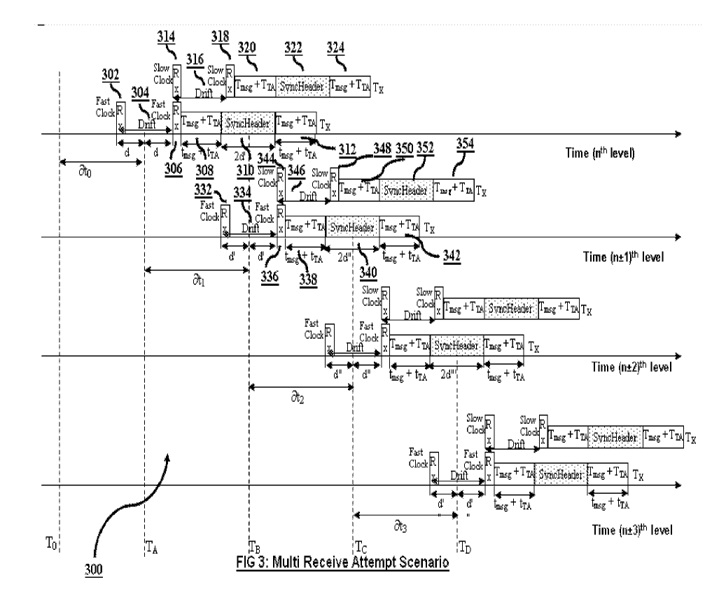

FIG. 3 is similar to FIG. 2 except that in this case the receiver node attempts to listen for the relevant data couple of times. The size of SyncHeader i.e. the sequence of MIF 310, 322, 340, 352 has been accordingly reduced to 2 times the drift as per equation 1. As illustrated in FIG. 3, depending upon the clock drift, the receiver node attempts to listen plurality of times 302, 306 or at 314, 318. After decoding the MIF at one of the receive attempt, receiving node synchronizes with transmitting node and calculates the time when the data frame i.e. 308 or 320 will be transmitted. Similar to the above case, after receiving the data frame and with the proper delay of T_{msg}+T_{TA} duration the node changes to transmit mode and starts transmitting the MIF sequence 310, 322 for the next layer. Similar to the transmitting node procedure, the next layer node starts its reception procedure at 332, 336 or at 344, 348 and continue in same way as the previous layer.

FIG. 4 illustrates an exemplary message indication frame sequence 400, introduced as part of this invention. 420 illustrates an exemplary message indication frame (MIF), which contains a preamble data (PD) 402 of 4 octet, a start frame delimiter (SFD) of 1 octet 404 and a 2 octet block 406, which contains message indication identifier (MII) and blocks before data packet (BBD). Based on hardware capability the length of preamble data is calculated, as an example, AT86RF230 needs 80 microsecond to get synchronized and by default it adds 4 octets of preamble to any data before transmitting, that's why here as an example we have taken 4 octets of preamble data. Depending upon the network synchronization periodicity and maximum possible drift, the bit length of MII and BBD is configured and shared with all the network elements. According to the size of MII, the network decides MII content. Depending upon the requirement, MII content is configurable at network basis or at each layer of the network basis or at per node basis. BBD contains the count of MIF to be transmitted before the data frame.

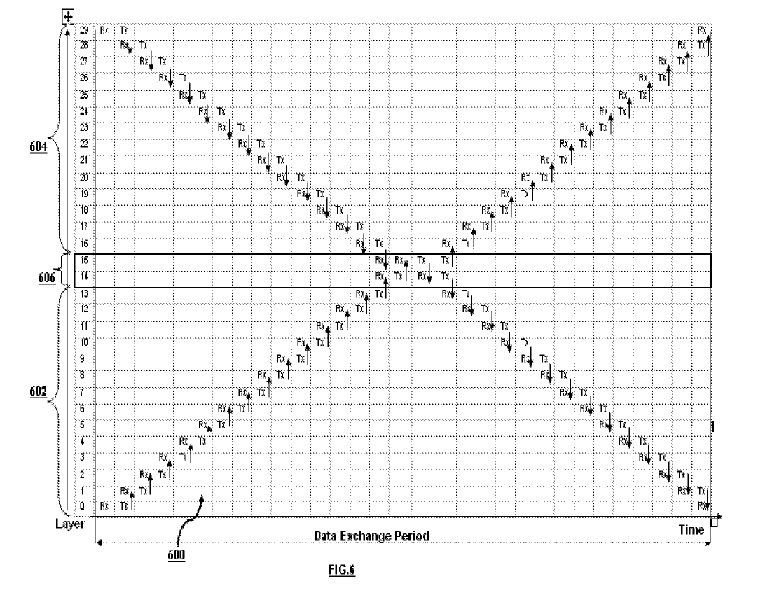

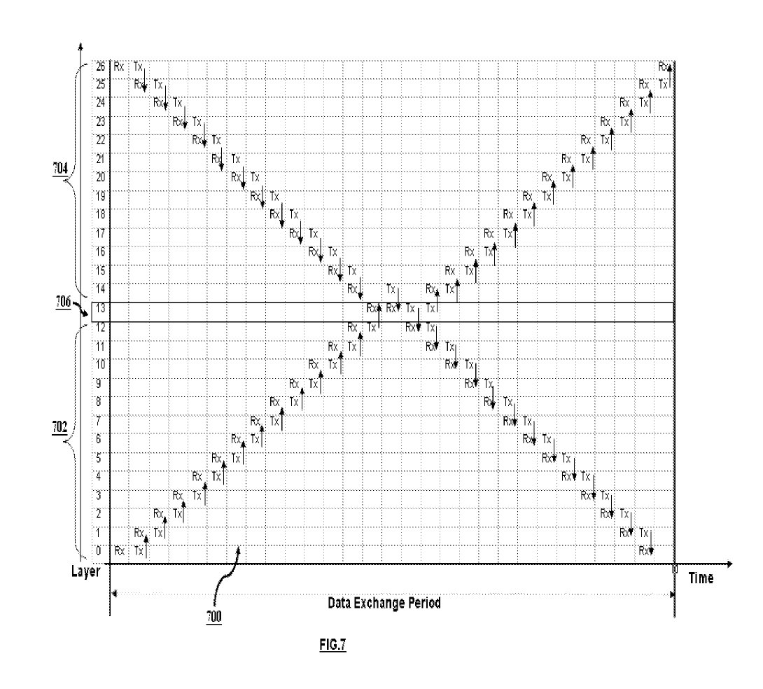

FIG. 6 and FIG. 7 illustrates how the data frame is propagating between the layers. As part of this invention, the network can be divided into plurality of clusters of layers. As we know that a large network will have plurality of layers of coordinators. These contiguous layers can be grouped together to form a cluster. Depending upon the size of the network and requirement, the cluster size is configured. FIG. 6 and FIG. 7 illustrates that the network is divided in two clusters 602, 604 and 702, 704. 606 and 706 is interface layer, which connects two clusters. By dividing the network into clusters, the data propagation can be made faster because as illustrated in FIG. 6 and FIG. 7 the forward and reverse data propagation can happen at the same time at different layers.

As part of this invention we have formulated the time at which NCs at different layer activate theirs transceiver in reception and transmission mode to support different directional data flow. By default transceiver activates in reception mode at its scheduled time, but activates in transmission mode only if the node has data packet to propagate. Using our patents on synchronization, it is possible to configure the synchronization periodicity to a very large value, in the range of minutes to improve the power efficiency of network. As discussed earlier, in defense there are use-cases where data exchange between the nodes happens rarely, but whenever it has to exchange, it needs to happen in minimum delay. To cater such requirement most power efficiently, in this invention we have designed a periodic receive concept where the node activates its receiver for configurable minimum period (Tₘᵢₙ_{_{—}}_{Rx}) of time in which it detects whether any relevant data is getting transmitted or not. If the node doesn't find any signal it goes to sleep mode again till the next periodic listen period. As illustrated in FIG. 2 and FIG. 3 the nodes become active in reception mode at previous layer node's transmission time as per its local clock. The active period is a configurable period at any layer and is sufficiently large enough to accommodate data processing, acknowledgement, propagation delay, and turn-around time. This makes sure that data is propagated between any two layers with minimum delay. Normally data propagation is faster in one direction; the direction in which the active phase of the nodes follows. In the reverse direction, the data propagation happens only with the next layer in every active phase time period which can take unacceptable amount of time in case of large networks. As part of this invention we have proposed to schedule the active phase of layers in such a way that periodically in sequence it favors one of the configured directions for data propagation.

In this section, we will derive the formula to calculate the transmission and reception time at which any layer attempts to transmit or receive to support different directional data flow. Assuming T₀ is the time at which PC starts the data propagation in forward direction, then:

PC_{Tx}_{_{—}}ₛ=T₀; PC Transmission (Tx) start time

PC_{MIF}=T₀*s, PC MIF sequence duration

PC_{Tx}_{_{—}}ₑ=T₀*(1+s)+T_{msg}; PC Tx end time

where,

s=(4*Δ)/A; as per equation 1

Δ is the maximum drift supported by the network;

Putting z=1+s;

PC_{Tx}_{_{—}}ₑ=T₀*z+T_{msg};

T₁_{_{—}}_{Tx}_{_{—}}ₛ=T₀*z+T_{msg}+T_{TA}; Layer 1 node Tx start time

T₁_{_{—}}_{Tx}_{_{—}}_{MIF}=T₁_{_{—}}_{Tx}_{_{—}}ₛ*z; Layer 1 node MIF sequence duration

T₁_{_{—}}_{Tx}_{_{—}}ₑ=T₀*z²+(T_{msg}+T_{TA})*z+T_{msg}; Layer 1 Tx end time

T₂_{_{—}}_{Tx}_{_{—}}ₛ=T₀*z²+(T_{msg}+T_{TA})*(1+z); Layer 2 node Tx start time

T₂_{_{—}}_{Tx}_{_{—}}_{MIF}=T₂_{_{—}}_{Tx}_{_{—}}ₛ*s; Layer 2 node MIF sequence duration

T₂_{_{—}}_{Tx}_{_{—}}ₑ=T₀*z³+(T_{msg}+T_{TA})*(z+z²)+T_{msg}; Layer 2 Tx end time

T₂_{_{—}}_{Tx}_{_{—}}ₑ_{_{—TA}}=T₀*z³+(T_{msg}+T_{TA})*(z+z²)+T_{msg}+T_{TA}; Layer 2 Tx end time including turn-around time

Similarly, for nth layer node:

Tₙ_{_{—}}_{Tx}_{_{—}}ₛ=T₀*zⁿ+(T_{msg}+T_{TA})*(zⁿ−1)/(z−1); Layer n node Tx start time

Tₙ_{_{—}}_{Tx}_{_{—}}_{MIF}=Tₙ_{_{—}}_{Tx}_{_{—}}ₛ*s; Layer n node MIF sequence duration

Tₙ_{_{—}}_{Tx}_{_{—}}ₑ=T₀*zⁿ⁺¹+(T_{msg}+T_{TA})*(z+z² . . . +zⁿ)+T_{msg}; Layer n Tx end time

Tₙ_{_{—}}_{Tx}_{_{—}}ₑ_{_{—}}_{TA}=T₀zⁿ⁺¹+(T_{msg}+T_{TA})*(z+z² . . . +zⁿ)+T_{msg}+T_{TA}; Layer n Tx end time including turn-around time

[symbol]

Tₙ_{_{—}}_{Tx}_{_{—}}ₑ_{_{—}}_{TA}=T₀zⁿ⁺¹+(T_{msg}+T_{TA})*(zⁿ⁺¹−1)/(z−1);

i.e.

$$\begin{matrix}{T}_{n\_Tx \_s} = {T}_{0} * {z}^{n} + ( {T}_{msg} + {T}_{NA} ) * ( \frac{{z}^{n} - 1}{z - 1} ) ; & equation 2 \\ {T}_{n\_Tx \_e \_TA} = {T}_{0} * {z}^{n + 1} + ( {T}_{msg} + {T}_{TA} ) * ( \frac{{z}^{n + 1} - 1}{z - 1} ) ; & equation 3\end{matrix}$$

Since the transmission time of nth layer and reception time of (n+1)th layer is same, the data propagation delay for n layers is equal to T₍ₙ₋₁)_{_{—T}}ₓ_{_{—}}ₑ_{_{—T}}_{A}−T₀:

$${Delay}_{n} = {T}_{0} * ( {z}^{n} - 1 ) + ( {T}_{msg} + {T}_{TA} ) * ( \frac{{z}^{n} - 1}{z - 1} ) \qquad equation 4$$

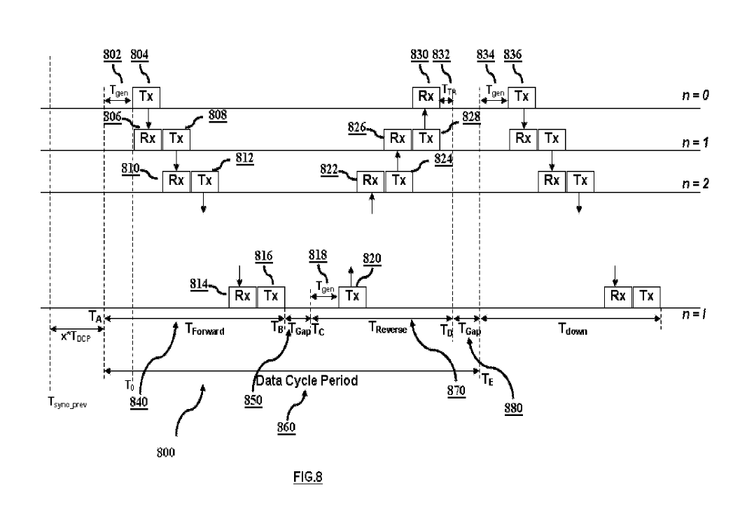

Having calculated the data propagation delay and transmission time as per its local clock based on its depth from the PC, now depending upon the network requirement the value of T₀ is calculated and configured. FIG. 8 illustrates the time domain of an 1 layer network when the network is configured to support only forward and reverse directional data propagation. Section below describes the generic formula using which any directional data propagation is also possible. Different terminologies used for the network time domain is also illustrated. There can be plurality of ways in which network can be configured such that 1) Constant values T_{Gap} (850) and T′_{Gap} (880), which will make variable size data cycle period 860. 2) Constant data cycle period 860, in this case depending upon the requirement minimum gap is configured and based on that all other values are calculated. As an illustration in this document, second scenario is described where data cycle period (DCP) is configured constant. It shall not be taken as limitation; the proposed algorithm can be used to configure to support any type of network configuration. FIG. 8, illustrates 1 layer network; the network configuration is such that the active phase first follows from the PC towards the higher layer nodes and then after reaching the cluster boundary or last layer of the network the active phase of the nodes starts following in reverse direction. T_{Gap} (850 or 880) is the configurable time lag while changing the data flow direction.

In FIG. 8, T_{gen} 802, 818, 834 indicates the data generation time, Tx 804, 808, 812, 816, 836 indicates the data transmission time from each layer in forward direction i.e. from PC to higher layers, Rx 806, 810, 814 indicates the data reception time at each layer from the previous layers in the forward direction, Tx 820, 824, 828 indicates the data transmission time from each layer in the reverse direction i.e. from the higher layer towards the PC, Rx 822, 826, 830 indicates the data reception time in reverse direction. T_{Forward} 840 indicates the total data propagation time along the forward direction, T_{Reverse} 870 indicates the total data propagation time along the reverse direction, T_{Gap} 850, 880 indicates the minimum time gap to be maintained at the time of change of data propagation direction. Data Cycle Period 860 indicates the total time needed for the data propagation along the forward and reverse direction, T_{TA} 832 indicates the turn around time which is the time needed for change of transceiver mode from reception to transmission mode or vice-versa for the next transaction.

Formula derivation for network configuration where the data cycle period (DCP) is constant is described below.

As we know from our previous patents that periodicity of synchronization process can be configured based on the network requirement. Here we are assuming that the synchronization periodicity is T_{sync}. In the worst case i.e. just before next synchronization process (drift will be maximum), and assuming T_{minGap} is the minimum time delay at the time of change of data flow direction, the delay T_{maxDel} in data propagation in 1 layer network using equation 4 is:

$${T}_{max Del} = ( {T}_{sync} - {T}_{max Del} - {T}_{min Gap} ) * ( {z}^{n} - 1 ) + ( {T}_{msg} + {T}_{TA} ) * ( \frac{{z}^{n} - 1}{z - 1} ) ; \\ ⇒ {T}_{max Del} = ( \frac{{z}^{n} - 1}{{z}^{n}} ) * [ ( {T}_{sync} - {T}_{min Gap} ) + \frac{{T}_{msg} + {T}_{TA}}{z - 1} ] ;$$

where
A=number of attempts receiving node makes to listen to data

$$s = \frac{4 Δ}{A} ;$$

$$z = 1 + s ;$$

Corresponding to T_{maxDel}, the maximum number of complete DCP (N_{DCP}) is:

$${N}_{DCP} = ⌊ \frac{{T}_{sync}}{2 ( {T}_{maxDel} + {T}_{minGap} + {T}_{gen} )} ⌋$$

where, T_{gen} is the maximum time required to generate any data packet. For the network having constant DCP, the DCP is calculated as follows:

$${T}_{DCP} = \frac{{T}_{sync}}{{N}_{DCP}} ;$$

Putting the proper value for T₀ in equation 2 for x^{th} data cycle, the transmission time is calculated by:

$${T}_{n\_Tx \_fwd \_x} = ( x * {T}_{DCP} + {T}_{gen} ) * {z}^{n} + ( {T}_{msg} + {T}_{TA} ) * ( \frac{{z}^{n} - 1}{z - 1} ) ;$$

Similarly for reverse direction Tx time is calculated by:

$${T}_{n\_TX \_rev \_x} = ( ( x + 0.5 ) * {T}_{DCP} + {T}_{gen} ) * {z}^{maxDepth - n} + ( {T}_{msg} + {T}_{TA} ) * ( \frac{{z}^{maxDepth - n} - 1}{z - 1} ) ;$$

where, maxDepth is the cluster size or maximum depth of the network.

As mentioned earlier the node attempts to listen to previous layer data transmission at t₀−(2*d−½) particularly when the SyncHeader duration is less than 2 times the maximum possible drift i.e. number of attempts (A) is greater than 2 according to equation 1. Therefore the reception (Rx) time of any node at n^{th} layer in x^{th} DCP in forward direction for m^{th} attempt is:

$${T}_{n\_Rx \_fwd \_x \_m} = [ ( x * {T}_{DCP} + {T}_{gen} ) * {z}^{n - 1} + ( {T}_{msg} + {T}_{TA} ) * ( \frac{{z}^{n - 1} - 1}{z - 1} ) ] * [ 1 - 2 * Δ + ( m - 0.5 ) * \frac{4 Δ}{A} ] ; … for A > 2$$

In case of single attempt i.e. A=1, the receiving node attempts at t₀ and in case of two attempts i.e. A=2, the receiving node attempts at t₀−(d−½). Hence the generic formula for any value of A is:

$${T}_{n\_Rx \_fwd \_x \_m} = [ 1 - \{ 2 - ⌊ \frac{2}{A} ⌋ \} * Δ + ( m - 0.5 ) * \frac{4 Δ}{A} ] * [ ( x * {T}_{DCP} + {T}_{gen} ) * {z}^{n - 1} + ( {T}_{msg} + {T}_{TA} ) * ( \frac{{z}^{n - 1} - 1}{z - 1} ) ] ;$$

Similarly, for reverse directional data flow:

$${T}_{n\_Rx \_rev \_x \_m} = [ 1 - \backslash \{ 2 - ⌊ \frac{2}{A} ⌋ \} * Δ + ( m - 0.5 ) * \frac{4 Δ}{A} ] * [ ( ( x + 0.5 ) * {T}_{DCP} + {T}_{gen} ) * {z}^{maxDepth - ( n + 1 )} + ( {T}_{msg} + {T}_{TA} ) * ( \frac{{z}^{maxDepth - ( n + 1 )} - 1}{z - 1} ) ] ;$$

As mentioned earlier, our proposed algorithm can support multidirectional data propagation. Similar to 840 and 870 illustrated in FIG. 8, which illustrates the T_{Forward} and T_{Reverse} when the network is configured to support only forward and reverse directional data flow; the data cycle period 860 is divided into plurality of time zones, which is equal to number of directions the network is configured to support the data flow. Also the order of data flow can be configured based on the application requirement i.e. the time domain of data cycle period can be configured in any order such as T_{Forward} then T_{Reverse} and then T_{Peer} or, T_{Peer} then T_{Forward} and then T_{Reverse}. Assuming that the network is configured to support k directions i.e. NwkDir=k, and the directions are defined as Dir_{—}0, Dir_{—}1, . . . Dir_(k−1), also each is assigned an enumerated value from 0 to k−1, then the above formulas can be written as follows in generic manner:

$${N}_{DCP} = ⌊ \frac{{T}_{sync}}{NwkDir ( {T}_{maxDel} + {T}_{minGap} + {T}_{gen} )} ⌋ ;$$

Transmission time of n^{th} layer node in j^{th} direction i.e. Dir_j, in x^{th} DCP is:

$${T}_{n\_Tx \_Dir \_j \_x} = [ ( x + \frac{Dir\_j}{NwkDir} ) * {T}_{DCP} + {T}_{gen} ] * {z}^{n} + ( {T}_{msg} + {T}_{TA} ) * ( \frac{{z}^{n} - 1}{z - 1} ) ;$$

except for reverse directional data flow. For reverse directional data flow the transmission time is:

$${T}_{n\_Tx \_Dir \_i \_x} = [ ( x + \frac{Dir\_i}{NwkDir} ) * {T}_{DCP} + {T}_{gen} ] * {z}^{maxDepth - n} + ( {T}_{msg} + {T}_{TA} ) * ( \frac{{z}^{maxDepth - n} - 1}{z - 1} ) ;$$

assuming Dir_i is for reverse direction.

SynchHeader length at any particular instance is 4 times the maximum possible drift at that particular instance divided by number of reception attempts, for any directional data flow as per equation 1, i.e.

$${T}_{SH\_LEN} = \frac{4 * Δ * T}{A}$$

where, T is the transmission time since last synchronization.

Similarly, the reception time for n^{th} layer node in j^{th} direction i.e. Dir_j in x^{th} DCP for m^{th} attempt is calculated using formula below:

$${T}_{n\_Rx \_Dir \_j \_x \_m} = [ 1 - \{ 2 - ⌊ \frac{2}{A} ⌋ \} * Δ + ( m - 0.5 ) * \frac{4 Δ}{A} ] * [ ( {T}_{DCP} * ( x + \frac{Dir\_j}{NwkDir} ) + {T}_{gen} ) * {z}^{n - 1} + ( {T}_{msg} + {T}_{TA} ) * ( \frac{{z}^{n - 1} - 1}{z - 1} ) ] ;$$

except for reverse directional data flow. For reverse directional data flow the reception time is:

$${T}_{n\_Rx \_Dir \_i \_x \_m} = [ 1 - \{ 2 - ⌊ \frac{2}{A} ⌋ \} * Δ + ( m - 0.5 ) * \frac{4 Δ}{A} ] * [ ( {T}_{DCP} * ( x + \frac{Dir\_i}{NwkDir} ) + {T}_{gen} ) * {z}^{maxDepth - ( n + 1 )} + ( {T}_{msg} + {T}_{TA} ) * ( \frac{{z}^{maxDepth - ( n + 1 )} - 1}{z - 1} ) ] ;$$

assuming Dir_i is for reverse direction.

where,
x=1, 2, 3, . . . , N_{DCP}−1;
n=0, 1, 2, . . . 1 (maximum possible depth);
m=1, 2, . . . A (maximum number of attempts);
Δ=maximum drift supported; and
NwkDir=number of directions the network is configured to support data propagation.

For the network operating on single frequency, the neighboring coordinator nodes divides its region into different time zones. Each zone has time offset sufficient enough to complete the whole data exchange without overlapping on other's time zone, even in worst possible drift case.

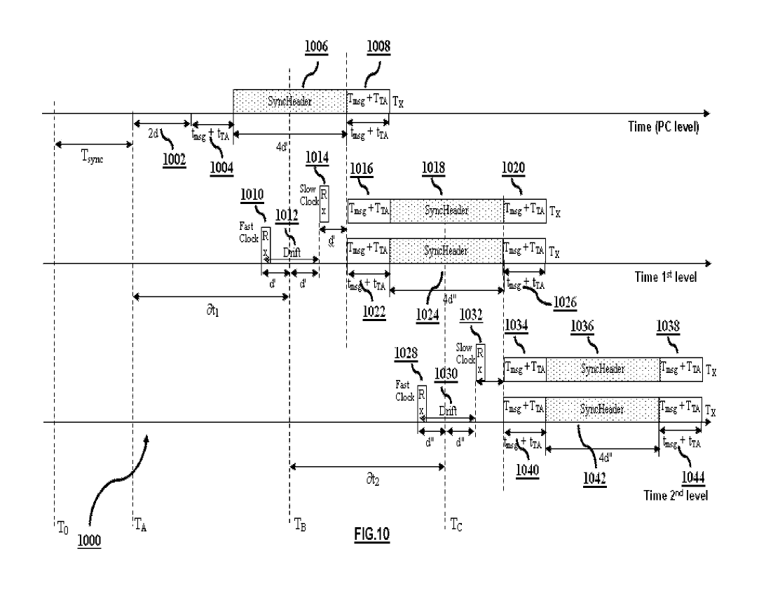

As shown in FIG. 10 the proposed data propagation method is also used to propagate the synchronization information. As illustrated in this figure, at each layer there is a delay in synchronization information transmission after the reception from the previous layer to accommodate the SyncHeader i.e. MIF sequence, so that the next layer listens to the synchronization information without fail. Delay at each layer will add the drift in synchronization information. According to the equation 4, the data propagation delay at the synchronization time (T_{sync}) is:

$${Delay}_{sync} = {T}_{sync} * ( {z}^{l} - 1 ) + ( {T}_{msg} + {T}_{TA} ) * ( \frac{{z}^{l} - 1}{z - 1} )$$

where l=max depth

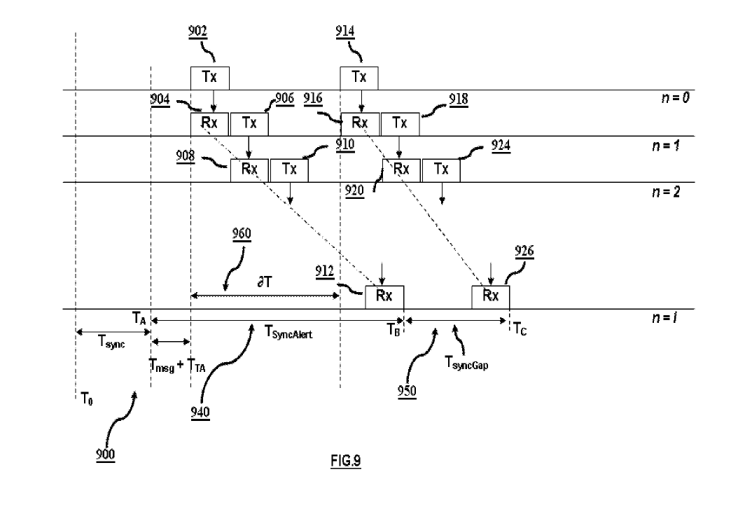

As illustrated, the value of Delay_{sync} depends on the value of z, T_{msg}, T_{TA}, l, and T_{sync} where z depends on Δ and A (i.e. maximum number of attempts). According to the above equation for some reasonable values of z, T_{msg}, T_{TA}, l, and T_{sync}, the value of Delay_{sync} can go in range of seconds, which implies that the drift in synchronization information can be greater than 40 micro seconds, since as per IEEE 802.15.4-2006 standard the protocol supports clock drift up to 40 ppm. Drift in range of 40 micro seconds and higher may not be acceptable for some applications. To overcome this issue, we have proposed a method as illustrated in FIG. 9. As per this method, at T_{sync} the PC first propagates an synchronization alert frame (940) to its network stating that the synchronization information frame will follow. The delay in transmission of synchronization information frame is designed such that, at the highest level network elements the synchronization information frame reaches after synchronization alert frame after configurable amount of time T_{syncGap} 950. As per equation 4, the synchronization alert frame will propagate through the network in T_{syncAlert} 940 time:

$${T}_{SyncAlert} = {T}_{sync} * ( {z}^{l} - 1 ) + ( {T}_{msg} + {T}_{TA} ) * ( \frac{{z}^{l} - 1}{z - 1} )$$

where l=max depth

As illustrated, 902 is synchronization alert frame transmitted by PC and 914 is synchronization information frame transmitted by the PC after ∂T time 960. Hence the propagation delay of synchronization information frame is:

$${T}_{syncInfo} = {T}_{syncAlert} + {T}_{syncGap} - \partial T$$

$${T}_{syncInfo} = \partial T * ( {z}^{l} - 1 ) + ( {T}_{msg} + {T}_{TA} ) * ( \frac{{z}^{l} - 1}{z - 1} ) \\ ⇒ \partial T = \frac{{T}_{sync} * ( {z}^{l} - 1 ) + {T}_{syncGap}}{{z}^{l}}$$

$$where \text{:}$$

$$z = 1 + \frac{4 Δ}{A} ;$$

A=maximum number of attempts to listen to relevant data Hence

$${T}_{syncInfo} = {T}_{syncAlert} + {T}_{syncGap} - \frac{{T}_{sync} * ( {z}^{l} - 1 ) + {T}_{syncGap}}{{z}^{l}} ;$$

Using this method the T_{syncInfo} comes down to milliseconds range, which implies that the drift in synchronization information comes down to 2-4 microseconds range.

What is claimed is:

1. A method for propagating data packet in power efficient and in minimum delay in configurable directions (NwkDir) in a wireless communication network, comprising steps of:
dividing the time period between two consecutive synchronization process into plurality of data cycle period (DCP) based on configurable parameters;
dividing said data cycle period (DCP) into plurality of time zones, each dedicated for specific directional data flow, based on configurable parameter NwkDir which holds the value to indicate the number of directions said network supports the data propagation;
network element activating its transceiver in reception mode in each said time zones of each said data cycle period for preconfigured duration (Tₘᵢₙ_{_{—}}_{RX}) at particular time calculated based on min RX configurable parameters, to check whether previous layer is transmitting any data for it or not;
network element calculating transmission start time (Tₙ_{_{—}}_{Tx}_{_{—}}_{Dir}_{_{—}}ⱼ_{_{—}}ₓ) based on its depth, direction in which data packet has to be propagated, current said data cycle period (DCP) count and configurable parameters, provided it has data packet to propagate;
network element calculating synchronization header (SyncHeader) duration (T_{SH}_{_{—}}_{LEN}) i.e. message indication frame (MIF) sequence duration based on said transmission start time (Tₙ_{_{—}}_{Tx}_{_{—}}_{Dir}_{_{—}}ⱼ_{_{—}}ₓ) with respect to last synchronization activity and number of reception attempt the next layer node will make to listen to the data packet, provided it has data packet to propagate; and
network element activating its transceiver in transmission mode and transmitting said data packet at said transmission start time (Tₙ_{_{—}}_{Tx}_{_{—}}_{Dir}_{_{—}}ⱼ_{_{—}}ₓ), provided it has data packet to propagate;
whereby data propagation between any network elements is achieved within configurable delay in power efficient manner.

2. The method, as claimed in claim 1, wherein said data cycle period (DCP) is divided into number of said time zones equal to number of directions the network is configured to support data propagation, each said time zone is dedicated to a specific directional data flow, data cycle period (DCP) calculation comprising steps of:
calculating the maximum possible delay (T_{maxDel}) in propagating data packet from personal area network controller (PC) to the highest depth network element of said network;
adding configurable duration (T_{conf}) sufficient enough to generate data packet (T_{gen}) i.e. T_{conf}>T_{gen}, to said calculated maximum possible delay (T_{maxDel}) i.e. T_{maxDel}+T_{conf};
obtaining the minimum time required to propagate data packet in all configured directions (NwkDir) by multiplying the value obtained during said adding configurable duration (T_{conf}) and said calculated maximum possible delay (T_{maxDel}+T_{conf}) with said number of directions the network supports data propagation (NwkDir) i.e. NwkDir*(T_{maxDel}+T_{conf});
obtaining number of complete cycles of data propagation (N_{DCP}) in all configured directions by dividing the time period between two consecutive synchronization process (T_{sync}) with the value obtained after said multiplication with said NwkDir i.e.
$${N}_{DCP} = ⌊ \frac{{T}_{sync}}{NwkDir ( {T}_{max Del} + {T}_{conf} )} ⌋ ;$$
and
obtaining the duration of said data cycle period T_{DCP} by dividing DCP said synchronization periodicity T_{sync} with said number of complete cycle N_{DCP} i.e.
$${T}_{DCP} = \frac{{T}_{sync}}{{N}_{DCP}} ;$$
whereby said duration of data cycle period T_{DCP} and number of data DCP cycle period N_{DCP} between two consecutive synchronization process are obtained.

3. The method, as claimed in claim 1, wherein said time zone of said data cycle period is dedicated to a specific directional data propagation, said time zone duration is based on factors comprising:
said configurable parameter NwkDir stating the number of directions the network supports data propagation;
configurable parameter stating whether time gap between two consecutive data propagation directions is constant or data cycle is constant;
number of attempts made by next layer node to receive data packet;
maximum depth of current cluster or network;
maximum drift supported by the network;
active period during data propagation process at each layer; and
network synchronization periodicity.

4. The method, as claimed in claim 1, wherein said transmission time is designed in such a way that next layer node's transmission time follows the current layer node's transmission time with configurable time gap.

5. The method, as claimed in claim 1, wherein said message indication frame (MIF) is a data sequence comprising of preamble data (PD), start frame delimiter (SFD), message indication identifier (MII) and blocks before data packet (BBD).

6. A method for synchronizing data packet receiving network element with data packet transmitting network element before data packet transmission, comprising steps of:
said data packet transmitting network element calculating the minimum duration (T_{SH}_{_{—}}_{LEN}) for said message indication frame sequence transmission required to synchronize said data packet receiving network element before data packet transmission; and
said data packet transmitting network element transmitting said message indication frame sequence for calculated duration (T_{SH}_{_{—}}_{LEN}) to synchronize said data packet receiving network element before data packet transmission;
whereby data packet receiving network element gets synchronized with data packet transmitting network element.

7. The method, as claimed in claim 1, wherein said calculating synchronization header (SyncHeader) duration at any particular transmission time for configured number of reception attempts (A) by next layer network element, comprising steps of:
configuring said data packet receiving network element to listen to said synchronization header at middle of the synchronization header;
assuming said synchronization header duration as l;
calculating advancement of time at any particular instance required by said receiving network element for the scenario when transmitting network element is fast and the receiving network element is slow by maximum possible drift with respect to absolute time based on assumption that synchronization header duration is l and the receiving network element is configured to listen to said synchronization header at middle;
calculating maximum possible delay in receiving said synchronization header considering said advancement of time and for the scenario when the receiving network element is fast and the transmitting network element is slow by maximum possible drift with respect to absolute time; and
calculating the assumed synchronization header duration 1, for the condition when said receiving network element is covering said maximum possible delay in said configured number of attempts (A) wherein each said reception attempt is synchronization header duration apart;
whereby synchronization header duration is calculated.

8. As claimed in claim 1, the synchronization header duration (T_{SH}_{_{—}}_{LEN}) at any particular instance (T) using formula below:
$${T}_{{SH}_{LEN}} = \frac{4 * Δ * T}{A}$$
where,
T is the transmission start time since last synchronization,
A is the maximum number of reception attempt made by receiving network element,
Δ is maximum drift supported by network protocol.

9. The method, as claimed in claim 1, wherein said reception time is designed based on previous layer transmission time to attempt to listen to previous layer node transmission in each said time zones i.e. in each configured data propagation directions.

10. The method, as claimed in claim 1, wherein said network element attempts for preconfigured number of times during reception time to listen to previous layer node transmission in each said time zones i.e. in each configured data propagation directions.

11. The method, as claimed in claim 7, wherein said synchronization header (SyncHeader) duration (T_{SH}_{_{—}}_{LEN}) is the minimum period for which the current layer node transmits the synchronization information prior to data packet transmission, which is sufficient enough to synchronize next layer node even in worst possible drift condition.

12. The method, as claimed in claim 7, wherein said synchronization header duration is directly proportional to maximum drift supported by the network and time lapsed from previous synchronization process.

13. The method, as claimed in claim 7, wherein said synchronization header duration is inversely proportional to number of attempts the next layer node makes to listen to said data packet.

14. The method, as claimed in claim 1, wherein said transmission time, said reception time and said synchronization header duration is calculated based on:
number of attempts will be made by next layer node to receive said data packet;
current direction of data flow;
depth of current node;
maximum drift supported by the network;
active period during data propagation process;
network synchronization periodicity; and
time lapsed from previous synchronization process.

15. As claimed in claim 1, the reception time by nₜₕ layer node in j direction in xₜₕ data cycle period for mₜₕ reception attempt using formulas below:
$${T}_{{n}_{{Rx}_{{Dir}_{1}}}} m = {[ 1 - \{ 2 - ⌊ \frac{2}{A} ⌋ \} * Δ + ( m - 0.5 ) * \frac{4 Δ}{A} ]}^{x} * ¿ where Dir\_j$$
$$¿ [ ( {T}_{DCP} * ( x + \frac{{Dir}_{j}}{NwkDir} ) + {T}_{gen} ) * {z}^{n - 1} + ( {T}_{msg} + {T}_{TA} ) * ( \frac{{z}^{n - 1} - 1}{z - 1} ) ] ;$$
is all the configured directions except reverse direction, assuming Dir_i is for reverse direction then for reverse directional data flow reception time formula is:
$${T}_{{n}_{{Rx}_{{Dir}_{1}}}} m = {[ 1 - \{ 2 - ⌊ \frac{2}{A} ⌋ \} * Δ + ( m - 0.5 ) * \frac{4 Δ}{A} ]}^{x} * ¿$$
$$¿ [ ( {T}_{DCP} * ( x + \frac{{Dir}_{j}}{NwkDir} ) + {T}_{gen} ) * {z}^{max Depth - ( n + 1 )} + ( {T}_{msg} + {T}_{TA} ) * ( \frac{{z}^{max Depth - ( n + 1 )} - 1}{z - 1} ) ] ;$$
where,
x=1, 2, 3, . . . , N_{DCP}−1;
n=0, 1, 2, . . . l (maximum possible depth);
m=1, 2, . . . A (maximum number of attempts);
Δ=maximum drift supported;
s=(4*Δ)/A;
z=1+s;
NwkDir=number of directions the network supports data propagation; and
the directions are defined as Dir_0, Dir_1, . . . Dir_(k−1), and its value is assigned as an enumerated value from 0 to k−1.

16. As claimed in claim 1, the transmission time of nₜₕ layer node in j direction in xₜₕ data cycle period using formulas below:
$${{T}_{{n}_{{Tx}_{{or}_{1}}} = [ ( x + \frac{{Dir}_{j}}{NwkDir} ) * {T}_{DCP} + {T}_{gen} ] * {z}^{n} + ( {T}_{msg} + {T}_{TA} ) * ( \frac{{z}^{n} - 1}{z - 1} ) ;}}_{¿}^{x}$$
where Dir_j is all the configured directions except reverse direction, assuming Dir_i is for reverse direction then for reverse directional data flow transmission time formula is:
$${{T}_{{n}_{{Tx}_{{or}_{1}}} = [ ( x + \frac{{Dir}_{j}}{NwkDir} ) * {T}_{DCP} + {T}_{gen} ] * {z}^{max Depth - n} + ( {T}_{msg} + {T}_{TA} ) * ( \frac{{z}^{max Depth - n} - 1}{z - 1} ) ;}}_{¿}^{x}$$
where,
x=1, 2, 3, . . . , N_{DCP}−1;
n=0, 1, 2, . . . l (maximum possible depth);
m=1, 2, . . . A (maximum number of attempts);
Δ=maximum drift supported;
s=(4*Δ)/A;
z=1+s;
NwkDir=number of directions the network supports data propagation; and
the directions are defined as Dir_0, Dir_1, . . . Dir_(k−1), and its value is assigned as an enumerated value from 0 to k−1.

17. The cluster of claim 3 is the group of consecutive layers of wireless communication network in which said network is divided.

18. A method for achieving a high accuracy time synchronization, comprising steps of:
starting the synchronization procedure by transmitting synchronization alert frame (SAF);
calculating the time to transmit synchronization information frame (SIF), so that said synchronization information frame reaches the highest layer network elements at configurable period after said synchronization alert frame; and
transmitting said synchronization information frame at said time to transmit synchronization information;
whereby, time synchronization is achieved with high precision.

19. The method, as claimed in claim 18, wherein said synchronization alert frame is a data sequence comprising of information about said synchronization information frame transmission time.

20. The method, as claimed in claim 18, wherein said synchronization information frame is a data sequence comprising of network current time.

21. A system for networking a wireless communication device having networking capabilities with a wireless communication network as claimed in claim 1 comprising, a full function device personal area network controller (PC), a full function device network controller (NC) and a reduced function device leaf node (LN).

22. The full function device mentioned in claim 21 is a wireless networking device capable of calculating transmission time, reception time and said synchronization header duration, also it is capable of networking with reduced function device or other full function device and it is capable to operate in three modes serving as personal area network controller (PC), a network controller (NC) or as a leaf node (LN).

23. The reduced function device mentioned in claim 21 is a wireless networking device capable of calculating transmission time, reception time and said synchronization header duration, also it is capable of networking with only full function device and it can serve as leaf node (LN) in any network.
